(19) United States
(12) Patent Application Publication
(10) Pub. No.: US 2026/0303230 A1
(43) Pub. Date: Oct. 1, 2026

(54) REFLECTIVE INTELLIGENT SURFACE WITH SELF-DIAGNOSIS CAPABILITIES AND METHOD FOR OPERATING THE SAME

(71) Applicant: NEC Laboratories Europe GmbH, Heidelberg (DE)

(72) Inventors: Placido MURSIA, Heidelberg (DE); Marco ROSSANESE, Heidelberg (DE); Andres GARCIA-SAAVEDRA, Heidelberg (DE); Vincenzo SCIANCALEPORE, Heidelberg (DE); Xavier COSTA-PÉREZ, Heidelberg (DE)

(21) Appl. No.: 19/483,249

(22) PCT Filed: Nov. 22, 2023
(86) PCT No.: PCT/EP2023/082734

§ 371 Date: Nov. 11, 2025

(30) Foreign Application Priority Data
Jun. 21, 2023 (EP) 23180642.3

(51) Int. Cl. H04B 17/17; H04B 7/04

(52) U.S. Cl. CPC H04B 17/17; H04B 7/04013

(57) ABSTRACT

A reflective device includes an array of reflective elements under control of a control element, where each reflective element includes an antenna element configured to receive a radio-frequency (RF) signal incident on the reflective element. Each reflective element is operable in a functional operating state, in which the RF signal received by the antenna element of the reflective element is, at least partly, provided to be retransmitted by the antenna element of the reflective element. Each reflective element is operable in a diagnostic operating state, in which the RF signal received by the antenna element of the reflective element is, at least partly, provided as an RF signal usable for analysis purposes. The device and a method of using the device can be used to optimize states or decision making for a reflective device, and can also be used with artificial intelligence (AI) or machine learning (ML).

### CROSS REFERENCE TO RELATED APPLICATIONS

This application is a U.S. National Phase application under 35 U.S.C. § 371 of International Application No. PCT/EP2023/082734, filed on Nov. 22, 2023, and claims benefit to European Patent Application No. 23180642.3, filed on Jun. 21, 2023. The International Application was published in English on Dec. 26, 2024 as WO 2024/260573 A1 under PCT Article 21(2).

The project leading to this application has received funding from the European Union's Horizon 2020 research and innovation programme under grant agreement No 101017011.

### FIELD

The present invention relates to a reflective device comprising an array of reflective elements under control of a control element, as well as to a method for operating such reflective device.

### BACKGROUND

Reflective devices, such as those addressed in the present disclosure, are known, for example, as reflective intelligent surfaces (RISs), and are widely considered as one of the key technologies for next generation wireless systems, thanks to their unique ability to control the radio channel in a nearly passive way. By suitably optimizing the configuration of each RIS unit cell, the overall array can re-focus the incoming energy from the transmitter towards a specific receiver location in space while minimizing leakage towards undesired directions and the total power expenditure.

RISs are easy to manufacture, install, transport, and cheap to sell. Hence, from a market perspective, they are expected to be massively deployed in the environment, e.g., on the facades of buildings or on moving objects. However, one major drawback is that such RIS modules may be prone to experience failures due to difficulty of carrying out proper maintenance or external environmental factors such as meteorological phenomena, animals or people accidentally damaging the structure (for reference, see S. Kisseleff, S. Chatzinotas, and B. Ottersten, “Reconfigurable intelligent surfaces in challenging environments: Underwater, underground, industrial and disaster,” IEEE Access, vol. 9, pp. 150 214-150 233, 2021).

### SUMMARY

In an embodiment, the present disclosure provides a reflective device includes an array of reflective elements under control of a control element, where each reflective element includes an antenna element configured to receive a radio-frequency (RF) signal incident on the reflective element. Each reflective element is configured to be operable in a functional operating state, in which the RF signal received by the antenna element of the reflective element is, at least partly, provided to be retransmitted by the antenna element of the reflective element. Each reflective element is configured to be operable in a diagnostic operating state, in which the RF signal received by the antenna element of the reflective element is, at least partly, provided as an RF signal usable for analysis purposes. The device and a method of using the device can be used to optimize states or decision making for each reflective element of a reflective device, and can also be used with artificial intelligence (AI) or machine learning (ML).

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a diagram schematically illustrating a generic RIS hardware structure;

FIG. 2 is a diagram schematically illustrating a comparison between normal RIS operation (left) and a self-diagnosis state (right) in accordance with an embodiment of the present disclosure;

FIG. 3 is a diagram illustrating examples of output values at an analog-to-digital converter (ADC) of a RIS for a properly functioning RIS element (reference) and two different failure scenarios;

FIG. 4 is a diagram schematically illustrating a self-diagnose RIS design in the case of an RF switch-based implementation in accordance with an embodiment of the present disclosure;

FIG. 5 is a diagram schematically illustrating a self-diagnose RIS design in the case of a single Positive-Intrinsic-Negative (PIN) diode-based implementation in accordance with an embodiment of the present disclosure;

FIG. 6 is a diagram schematically illustrating a self-diagnose RIS design in the case of a varactor diode-based implementation in accordance with an embodiment of the present disclosure; and

FIG. 7 is a diagram schematically illustrating a self-diagnose RIS design with phase-measuring capabilities in accordance with an embodiment of the present disclosure.

### DETAILED DESCRIPTION

Accordingly, there may be a desire for cost-effective diagnosis techniques for faulty RIS elements, in order to avoid having to substitute the entire device or perform special maintenance operations.

In accordance with the present disclosure, embodiments include a reflective device comprising an array of reflective elements under control of a control element, wherein each reflective element includes an antenna element configured to receive a radio-frequency (RF) signal incident on the reflective element, and wherein each reflective element is configured to be operable in a functional operating state, in which an RF signal received by the antenna element of the reflective element is, at least partly, provided to be retransmitted by the antenna element of the reflective element, and in a diagnostic operating state, in which an RF signal incident on the reflective element is, at least partly, provided as an RF signal usable for analysis purposes.

Various examples of the present disclosure are based on the finding, that, a RIS board can be endowed with self-diagnosis capabilities by configuring the reflective elements of the board in such a way that they are operable in at least two different states: (i) a functional operating state, which is the “normal” RIS operating state, in which an incident RF signal is retransmitted by the antenna element of the reflective element, and (ii) a diagnostic operating state, in which an incident RF signal is provided as an RF signal usable for analysis purposes. The device may be constructed in such a way that each of the reflective elements is capable of being operated in the two states or that only a specific subset is capable of being operated in the two states, whereby in the latter case the diagnostic possibilities are of course limited compared to the first case. Further, in some examples the construction may be such that a reflective element can selectively only take one of the two states at the same time, while in other examples, it may be possible that a reflective element can operate both states concurrently.

In any case, according to the embodiments disclosed herein, a RIS board is endowed with self-diagnosis capabilities, such that the device is able, for instance, to automatically identify failures in its antenna elements or other components, without the need for explicit maintenance or exchange of specific control messaging with the rest of the network. As such, embodiments of the present disclosure provide a RIS with self-detection capabilities as well as methods for transparent self-detection of faulty RIS elements.

In some examples, each reflective element may further comprise a switching mechanism configured to allow putting the reflective element in either the functional operating state or the diagnostic operating state. The switching mechanism may be under control of the control element of the reflective device.

In some examples, each reflective element may further comprise a phase shifter having a tunable impedance, the phase shifter being under control of the control element so as to reflect an RF signal received by the antenna element of the reflective element with an adjustable phase shift, wherein different phase shifts are realized by respectively tuning the impedance of the phase shifter.

In some examples, the switching mechanism may include an RF gate, which herein is sometimes referred to as ‘equivalent gate’, since it can be implemented with different technologies (e.g., RF switch, PIN diode, variable impedance, etc., as will be explained in detail below), while its functionality remains the same, i.e., a gate that can be opened or closed as needed. Generally, when the gate is opened, the transmission line is in open circuit and the signal is reflected back (this can be done by setting a PIN diode to its “off” state, by unselecting the corresponding RF switch output, or by setting the variable impedance to a very high value, etc.). Whereas, when the gate is closed, the transmission line is closed and the signal passes through (this can be done by setting a PIN diode to its “on” state, by selecting the corresponding RF switch output, or by setting the variable impedance to a very low value, etc.). According to an embodiment, the RF gate may be connected downstream to the impedance of the phase shifter of the reflective element. For instance, to operate the reflective element in the functional operating state, the RF gate may be configured to leave the phase shifter open-circuited, such that the RF signal is reflected back to the antenna element. On the other hand, to operate the reflective element in the diagnostic operating state, the RF gate may be configured to connect the phase shifter, directly or indirectly, with the control element of the reflective device, such that the RF signal, at least partly, is not reflected back, but supplied as a dedicated RF signal that can be further processed and utilized, in particular for analytical/diagnostic purposes. The equivalent RF gate can be realized in several different ways, e.g., with a variable resistor, or a varactor diode.

According to a specific example, the phase shifter may be implemented in form of a set of discrete delay lines of different lengths and an RF switch connecting the antenna element with the discrete delay lines. The RF switch may be configured to selectively activate a particular one of the discrete delay lines, wherein each delay line corresponds to a specific phase shift. In such case, the RF gate might be implemented in form of variable impedances that are appended to the end of each of the delay lines. As such, by respectively tuning the impedance, preferably via the control element of the reflective device, the impedance can either cause the respective activated delay line to be open-circuited (effecting that the reflective element operates in its “normal” functional RIS operating state), or can cause the delay line to be closed-circuited (effecting that the reflective element operates in the diagnostic operating state).

According to another example, the phase shifter may be implemented in form of one or multiple PIN diodes. In such case, the RF gate might be implemented in form of a variable impedance appended at the output side of the one or multiple PIN diodes. Like in the previous example, by respectively tuning the impedance, preferably via the control element of the reflective device, the impedance can either cause the one or multiple PIN diodes of a reflective element to be open-circuited (effecting that the reflective element operates in its “normal” functional RIS operating state), or can cause the one or multiple PIN diodes to be closed-circuited (effecting that the reflective element operates in the diagnostic operating state).

According to another example, the phase shifter may include a varactor diode that is configurable in a number of different states depending on a value of a control voltage applied to the varactor diode. The configuration of the varactor diode is such that it is never open-circuited. Hence, in operation, there is always a certain (typically small) portion of an incoming RF signal that is not reflected back and that, as such, can be used for the self-diagnosis operation. Consequently, reflective elements equipped with a phase shifter in form of a varactor diode can operate at the same time both in the functional operating state and in the diagnostic operating state.

In some examples, the reflective device may further comprise a first central RF switch configured to forward, for one reflective element at a time, the RF signal, which is provided as the RF signal usable for analysis purposes when the respective reflective element is in the diagnostic operating state, to the control element of the reflective device. In order to allow for proper processing at the control element, the RF signal may first be converted by a first analog-to-digital converter (ADC), which may be implemented between the first central RF switch and the control element.

In some examples, the control element may be configured to periodically activate the diagnostic operating state for each reflective element separately. For instance, this may be achieved by controlling, by the control element, the central RF switch accordingly.

According to an example, which aims at enabling to obtain an estimate of the phase shift induced by a faulty antenna element of a reflective element, the reflective elements may further comprise an RF power divider configured to split an RF signal incident on the reflective element. A first portion of the signal may then be directed to the control element via a first branch including the tunable impedance, the first central RF switch and the first ADC. A second portion of the signal may be directed to the control element via a second branch including a second central RF switch and a second ADC. In such implementation, the control element may be configured to sample the incoming RF signals from the first and from the second branch and to determine the phase difference between the two signals. Based thereupon, the control element may compare the determined phase difference between the two signals with a reference value. If the comparison reveals a discrepancy, the control element may qualify the corresponding reflective element as faulty, and appropriate mitigation and/or remedy strategies may be initiated.

Some aspects of the present disclosure relate to a method for operating a reflective device according to the examples described above. According to an example, the method comprises the step of receiving, by the control element, an RF signal usable for analysis purposes provided by a reflective element in a diagnostic operating state and/or measurement values derived by a first ADC from said RF signal. The received RF signal and/or the received measurement values may then be analyzed by the control element and, based on the results of the analysis, the control element may determine whether the respective reflective element is faulty or not.

In some examples, the step of analyzing the received measurement values by the control element may include collecting a predefined or configurable series of measurement values and determining, from the collected series of measurement values, the maximum absolute value as representative value. Based thereupon, the control element may compare the representative value with a reference value. For instance, the reference value may be the respective value of any known functioning reflective element. If the comparison reveals a discrepancy, the control element may qualify the corresponding reflective element as faulty, whereupon appropriate mitigation and/or remedy strategies may be initiated.

In some examples, the method may further comprise a diagnosis step as follows: when the representative value determined from the collected series of measurement values is above zero, but significantly lower than the reference value, i.e., for instance, exceeding a predefined difference threshold, the control element may diagnose a malfunction in the antenna element of the corresponding reflective element. On the other hand, when the representative value determined from the collected series of measurement values is zero, the control element may diagnose a malfunction in the tunable impedance of the corresponding reflective element. In both cases, appropriate mitigation and/or remedy strategies may be initiated.

Generally, the reflective device may be designed and operated according to the concepts described in the document “Reconfigurable Intelligent Surfaces (RIS); Use Cases, Deployment Scenarios and Requirements”, Group Report, ETSI GR RIS 001 V1.1.1 (2023-04), which is hereby incorporated herein by reference.

There are several ways how to design and further develop the teachings of embodiments of the present invention in an advantageous way.

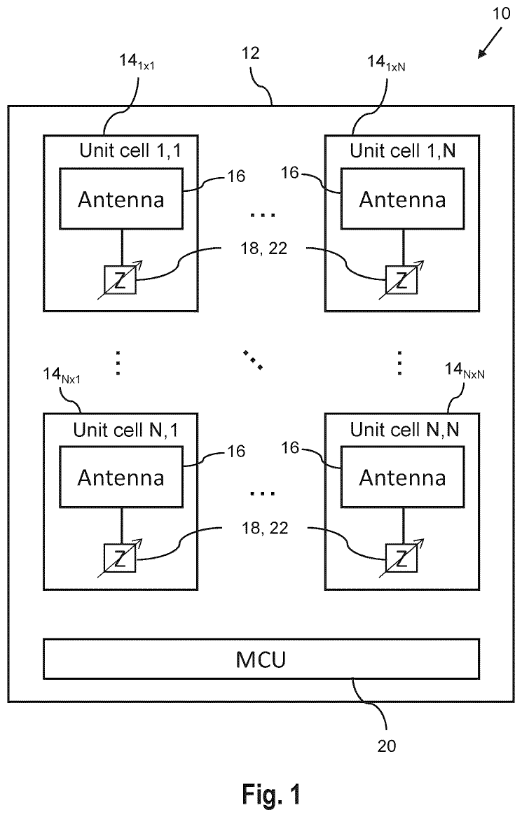

FIG. 1 depicts an example of a generic RIS hardware 10. In accordance with the basic RIS concept, the hardware 10 comprises a board or surface 12 including a number of reflective elements 14. In the illustrated example, the reflective elements 14₁, . . . , 14_{N×N} are arranged in form of a N×N4 array. Each reflective element 14, also known as unit cell, comprises an antenna element 16 and a phase shifter 18 including a reconfigurable impedance 22 used to realize different tunable phase-shifts on the impinging signal. Such tunable impedance 22 can be implemented in several ways, where some of the most common implementations include PIN diodes, varactor diodes, or delay lines (for reference, see M. Rossanese, P. Mursia, A. Garcia-Saavedra, V. Sciancalepore, A. Asadi, and X. Costa-Perez. 2022, “Designing, building, and characterizing RF switch-based reconfigurable intelligent surfaces”. In Proceedings of the 16th ACM Workshop on Wireless Network Testbeds, Experimental evaluation & CHaracterization (WINTECH &apos;22), 2022). Moreover, each RIS board 12 is equipped with a control element 20 (e.g., a central processing unit (CPU) such as a microcontroller unit (MCU), or the like), which is in charge of communicating the chosen configuration to each unit cell 14 as well as with any other external entities, as depicted in FIG. 1.

In terms of detection of faulty RIS elements, approaches exist already that are based on formulating an equivalent channel estimation problem, where the base station (BS) sends pilot sequences to the user via the RIS and then collects the associated measurements via a separate feedback channel. The measurements are then post-processed to determine which RIS elements are faulty and which is their (random) phase-shifting configuration (for reference, see, e.g., Li, B., Zhang, Z., Hu, Z., & Chen, Y. (2020). Joint Array Diagnosis and Channel Estimation for RIS-Aided mmWave MIMO System. IEEE Access, 8, 193992-194006, https://doi.org/10.1109/ACCESS.2020.3032775, or Sun, R., Wang, W., Chen, L., Wei, G., & Zhang, W. (2021). Diagnosis of Intelligent Reflecting Surface in Millimeter-wave Communication Systems. IEEE Transactions on Wireless Communications, 1-14, <<https://doi.org/10.1109/twc.2021.3125734>>). However, such methods require modifying the current network infrastructure to accommodate for specific training sequences used to detect faulty elements, as well as dedicated feedback control channels from the user-perceived measurements to the BS. Moreover, the available approaches are quite computationally intensive and need to be run on dedicated entities with sufficient computing power.

A second category of related work is represented by phased arrays, which are similar to RISs with the key difference that they are comprised of active (power-hungry) components. In this regard, detection of faulty elements is mainly done via one or more of the following approaches:
Thermal Imaging: This method involves the use of thermal cameras to detect faulty elements in the phased array, which produce more heat than normal elements due to increased resistance. Transmit-Receive Measurements: This method involves the use of a test signal to measure the response of each element in the phased array, since faulty elements will produce a different response than normal elements (for reference, see R. Palmeri, T. Isernia and A. F. Morabito, “Diagnosis of Planar Arrays Through Phaseless Measurements and Sparsity Promotion,” in IEEE Antennas and Wireless Propagation Letters, vol. 18, no. 6, pp. 1273-1277, June 2019, doi: 10.1109/LAWP.2019.2914529).
Pattern Measurements: This method involves measuring the radiation pattern of the phased array using a test signal. Faulty elements will produce a different pattern than normal elements. Time-Domain Reflectometry (TDR): This method involves measuring the reflection of a test signal from the phased array and detecting faulty elements that produce a different reflection than normal elements.
Electrical Impedance Measurements: This method involves measuring the electrical impedance of each element in the phased array and checking whether any element produces a different impedance than normal elements.
Automated Testing: This method involves the use of dedicated software and hardware, which is embedded on the phased array and is used to automatically test each element in the device (for reference, see K. Lee, R. Chu and S. Liu, “A built-in performance-monitoring/fault isolation and correction (PM/FIC) system for active phased-array antennas,” in IEEE Transactions on Antennas and Propagation, vol. 41, no. 11, pp. 1530-1540, November 1993, doi: 10.1109/8.267353).

It is noted, however, that the above-described methods require specific hardware/devices (e.g., thermal cameras, VNAs or RF chains embedded on the device), the use of specific channel estimation procedures, or rely on tailored measurements (e.g., in an anechoic chamber), making them expensive and inflexible. To address these issues, the present disclosure proposes systems and methods configured to jointly self-diagnose and automatically mitigate faulty elements. According to embodiments, the proposed systems/methods use simple passive components only and in a transparent manner to the existing network infrastructure.

Current RIS designs do not have the ability to self-detect faulty elements, or to mitigate the associated unwanted negative effects in terms of signal-to-noise ratio (SNR) at the intended receiver and signal leakage towards unwanted locations. Indeed, when RIS elements fail, the intended user experiences a drop in the SNR, but most importantly, the transmitted signal is spread along unwanted directions, causing interference to nearby users and potential security threats in the case of eavesdroppers.

The challenge that is addressed by the concepts proposed in the present disclosure is to endow RIS boards with self-diagnose capabilities by utilizing passive or semi-passive components only, in order to preserve the overall extreme low-power and low-cost footprint of such kind of devices. The methods and systems described herein are transparent to the rest of the network, meaning that a self-diagnosing RIS can be readily implemented in existing RIS-aided networks without the need to modify the network infrastructure.

With reference to FIG. 1, however, without loss of generality, the most common occurrences of a fault (CF) in a RIS board 12 are represented by:
1. Malfunction in the tunable impedance 22, which may be stuck in a given configuration, assume a generic random value, or disconnected from the RIS board 12 (this malfunction being denoted as CF1 hereinafter), and/or
2. Malfunction in the antenna element 16, which may alter its gain and/or radiation pattern, e.g., due to scratches on the surface (this malfunction being denoted as CF2 hereinafter).

In both cases, the resulting array response at the RIS exhibits large side lobes and a drop in the power associated with the main beam, causing both a drop in the user SNR and increased signal leakage towards undesired directions.

Embodiments of the methods and systems proposed herein address jointly the above-listed possible malfunctions, as well as mitigate the corresponding unwanted spreading of the signal along unintended directions.

According to embodiments of the present disclosure, the existing RIS hardware is enhanced by a separate “self-diagnose” state, herein sometimes referred to as diagnostic operating state, that is used to redirect an incoming signal from each unit cell 14 to the control element 20. The control element 20 may be configured to periodically activate the self-diagnose state of each unit cell 14 separately, and to analyze such signals in order to determine if the selected element 14 is faulty or not. Such activation may be performed on a regular basis, e.g., periodically in predefined time intervals, or on demand, in particular in case there is any suspicion of a malfunction.

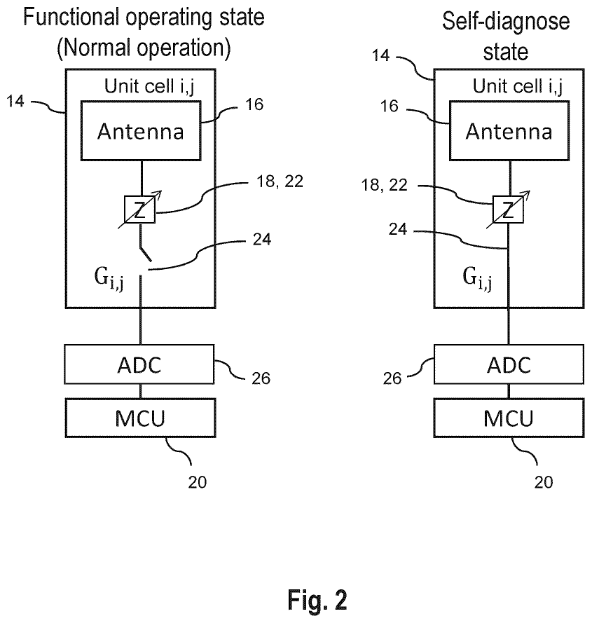

Activation of the diagnostic operating state may be effected by a dedicated switching mechanism, which may be implemented, e.g., in form an RF gate 24. Specifically, as shown in the general view of FIG. 2, an equivalent gate 24 (labeled as G_{i,j} in FIG. 2) may be appended to the tunable impedance 22 of each unit cell 14 (labeled as Z in FIG. 2). The gate 24 can be configured in one of two states, namely open-circuit (for normal operation, i.e. in this case the self-diagnose state is inactive), and short circuited otherwise (i.e. in this case normal operation is interrupted and the self-diagnose state is active). The gate 24 can be realized in several different ways, e.g., with a variable resistor, or a varactor diode as described in the embodiments below.

During normal operations, the gate 24 is left in open-circuit (as shown on the left side of FIG. 2) such that the RF signal coming from the antenna element 16 is reflected back to the antenna element 16, which continues to operate as expected. On the other hand, when the gate 24 is closed and configured as a short circuit (as shown on the right side of FIG. 2), the RF signal is directed towards the control element 20 and, hence, provided as a dedicated RF signal usable for analysis/diagnosis purposes. Specifically, as shown in FIG. 2, when the gate 24 is closed, the RF signal may be directed to flow through specific delay lines and is then collected by an analog-to-digital converter (ADC) 26, which enables processing at the control element 20.

In an example, the ADC 26 may be configured to collect several samples of the input signal and to forward them to the control element 20, which may then select as a representative the maximum absolute value of said samples. Based thereupon, the control element 20 may then compare the measurement related to the antenna element 16 of the unit cell 14 under test with a known reference to determine whether the selected unit cell 14 is faulty or not. In this regard, the value corresponding to any known functioning unit cell 14 may be used as a reference.

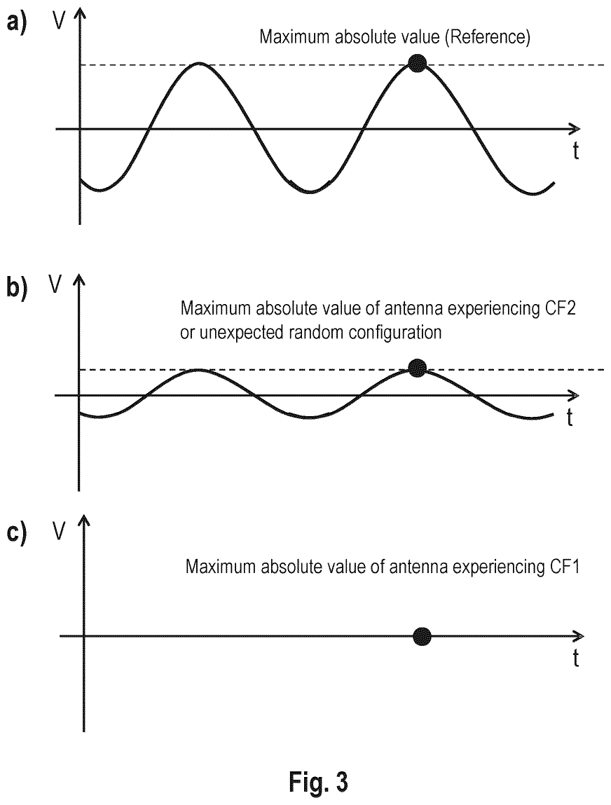

The idea is that whenever a unit cell 14 experiences one of the aforementioned possible faults, the maximum absolute sampled value will be different than expected. Some examples are illustrated in FIG. 3, while more details are given in the embodiments below. The measurements of a functioning unit cell 14, i.e. without any malfunctions, is illustrated in FIG. 3a). Specifically, in case of CF1, the measured value might be zero if the tunable impedance 22 is stuck in an unintended or improper configuration or is disconnected (as exemplarily illustrated in FIG. 3c)). Whereas if the tunable impedance 22 assumes a random state, the measured value will be significantly different than expected. On the other hand, in the case of CF2, the measured value will be significantly lower than the reference due to the power being dissipated by the faulty antenna 16 (as exemplarily illustrated in FIG. 3b)).

The self-diagnose and mitigation procedure according to the concepts disclosed herein may be executed either on demand or in regular time intervals. For instance, for standard communication purposes, it may be envisioned to enable the self-diagnosis procedure at the RIS board 12 approximately once per day. In this regard, it may be provided that, at a given time of the day, the control element 20 activates the diagnostic operating state subsequently for each reflective element 14 separately. Accordingly, the ADC 26 will be only powered seldom since it can be activated with a relatively low frequency depending on the particular application scenario. For standard communication purposes, it is envisioned to enable the self-diagnosis procedure at the RIS board approximately once per day.

Moreover, it is noted that one drawback of the proposed self-diagnosis procedure is that the selected unit cell 14 under test, as long as it is in the diagnostic operating state, does not contribute to the regular RIS operation, thus causing a slight drop in performance. However, since in the most application scenarios it is sufficient that the proposed procedure is operated only seldom and for one unit cell 14 at a time, this can be considered as a negligible performance degradation. Indeed, the SNR of RIS-aided networks scales with N², whereas it would scale as (N−1)² for each instance of the self-diagnosis procedure (with N denoting the number of unit cells 14 of the RIS device 10).

The overall self-diagnose and mitigation procedure according to an example can be summarized as follows:
1. The self-diagnose state of each unit cell 14 is periodically activated by the control element 20, such that the incoming signal is then redirected to the ADC 26 via a specific delay line.
2. The control element 20 collects measurements of the incoming signal via the ADC 26 and selects the maximum absolute value as a representative value.
3. If the resulting value is sufficiently different than a reference value, the antenna element 16 is dubbed as faulty.

Accordingly, with the aid of the self-diagnosis concepts disclosed herein, it is possible that, once a faulty antenna 16 is detected, the RIS controller 20 or any other entity in the network can exploit such information for various purposes, such as compensating by adjusting the RIS configuration, requesting special maintenance or the substitution of the entire RIS device 10.

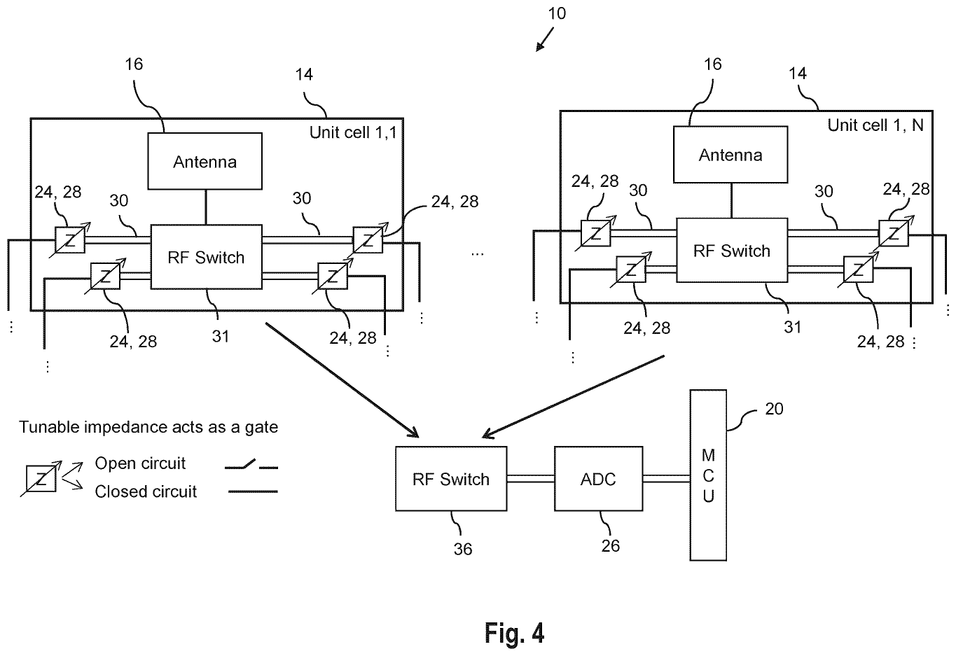

FIG. 4 schematically illustrates an implementation of the proposed self-diagnosis concepts in an RF switch-based RIS. In this case, the tunable impedance 22 of each unit cell 14 is implemented by a set of discrete delay lines 30 of different lengths corresponding to different phase shifts. An RF switch 31, which connects the antenna element 16 with the discrete delay lines 30, is configured to selectively activate a particular one of the discrete delay lines 30. As shown in FIG. 4, a variable impedance 28 that acts as a gate 24 is appended at the end of each delay line 30. Each delay line 30 of each unit cell 14 is then connected to a central RF switch 36, which is configured to enable only one unit cell 14 at a time and prevents the signal to spread to neighboring unit cells 14. The RF switch 36 is in turn connected to the ADC 26 and control element 20, as described above.

In case of a malfunction of the type CF1, the measured value at the control element 20 will be zero if the RF switch of the unit cell 14 is disconnected or stuck in an unintended or improper configuration. Whereas the measured value will be significantly lower than the reference in case of a malfunction of the type CF2.

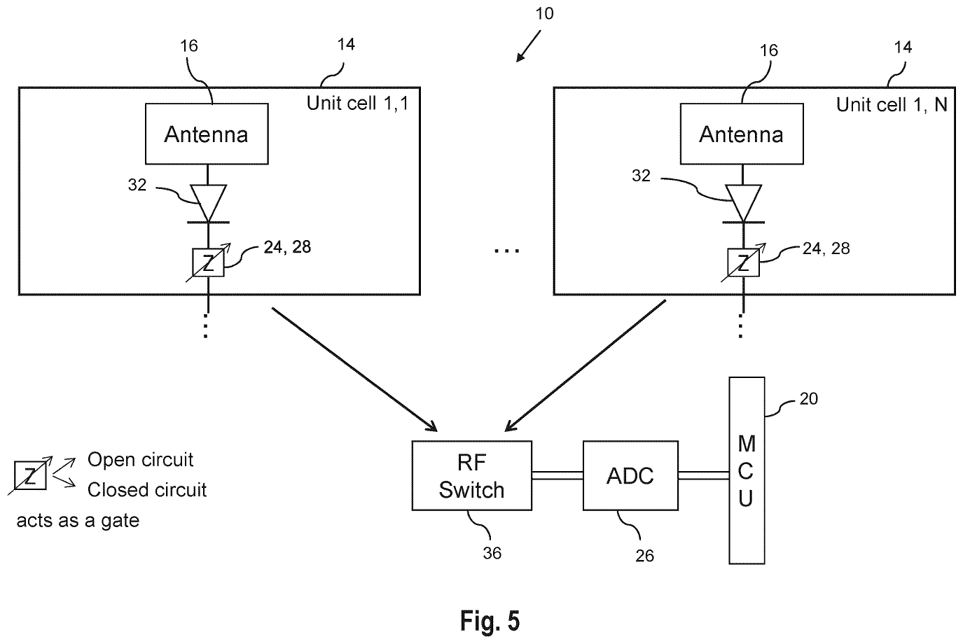

FIG. 5 schematically illustrates an implementation of the proposed self-diagnosis concepts in a PIN diode-based RIS. In this case, the tunable impedance 22 of each unit cell 14 is implemented by one or multiple PIN diodes 32, each of which can be configured in one of two alternative states (1-bit phase-shifting per each PIN diode 32). As shown in FIG. 5, a variable impedance 28 that acts as a gate 24 is appended at the end of each PIN diode 32. The PIN diode(s) 32 of each unit cell 14 is then connected to a central RF switch 36, which is configured to enable only one unit cell 14 at a time and prevents the signal to spread to neighboring unit cells 14. The RF switch 36 is in turn connected to the ADC 26 and control element 20, as described above.

In case of a malfunction of the type CF1, the measured value at the control element 20 will be zero if the PIN diode 32 of the unit cell 14 is disconnected or stuck in an unintended or improper configuration. Whereas the measured value will be significantly lower than the reference in case of a malfunction of the type CF2.

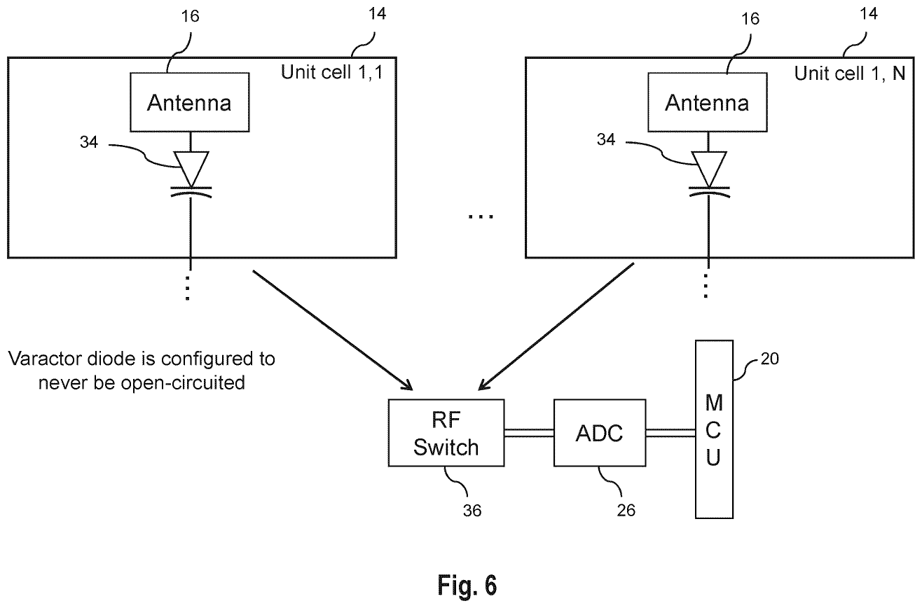

FIG. 6 schematically illustrates an implementation of the proposed self-diagnosis concepts in a varactor diode-based RIS. In this case, the tunable impedance 22 of each unit cell 14 is implemented by a varactor diode 34, which can be configured in several different states depending on the value of the associated control voltages applied to the diode 34. The configuration of the varactor diode 34 is such that it is never open-circuited. Hence, a (small) portion of an incoming signal will not be reflected back to the antenna element 16, but will flow to the control element 20 and can be used for the self-diagnosis operation. The varactor diode 34 of each unit cell 14 is then connected to a central RF switch 36, which is configured to enable only one unit cell 14 at a time and prevents the signal to spread to neighboring unit cells 14. The RF switch 36 is in turn connected to the ADC 26 and control element 20, as described above.

In case of a malfunction of the type CF1, the measured value at the control element 20 will be zero if the varactor diode 34 of the unit cell 14 is disconnected. If the varactor diode 34 is stuck in an unintended or improper (e.g., random) configuration, then the measured value will be significantly different than expected. Indeed, varactor diodes 34 experience different reflection coefficients depending on the applied control voltage. Such behavior is typically characterized during device fabrication and testing phase and can thus assumed to be known. On the other hand, the measured value will be significantly lower than the reference in case of a malfunction of the type CF2.

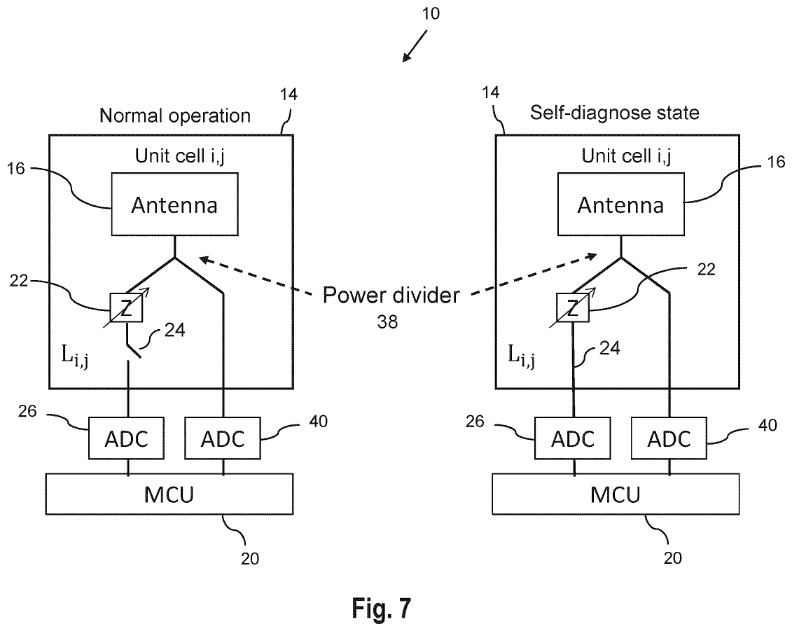

FIG. 7 schematically illustrates an embodiment of a phase measuring device in accordance with an embodiment of the present disclosure. Specifically, the illustrated self-diagnose RIS design allows to obtain an estimate of the phase-shift induced by faulty antenna elements 16. Such value is particularly useful to design effective mitigation strategies.

When an antenna element 16 is fully functioning, the phase of the incoming signal at the control element 20 is given by the summation of the initial phase θ₀ of the signal impinging on the antenna element 16, which is due to the distance travelled from the transmitter, plus the phase-shift θ_{i,j} imposed by the tunable impedance 22 of the corresponding unit cell 14, plus the phase-shift due to the distance L_{i,j} travelled from said unit cell 14 to the control element 20, denoted as θ_{D,i,j}. While θ₀ is in general unknown, both θ_{i,j} and θ_{D,i,j} are known, since the former is imposed by the given RIS configuration, while the latter computes as

$${θ}_{D , i , j} = \frac{360 {L}_{i , j} f}{c \cdot {v}_{f}} ,$$

where f is the operating frequency of the RIS, c is the speed of light, v_{f} is the velocity factor of the microstrip material, and L_{i,j} is the length of the delay line connecting the unit cell i, j with the control element 20. It should be noted that all such design parameters of the specific RIS device are known and fixed during manufacturing.

According to the embodiment illustrated in FIG. 7, the incoming signal is split into two separate branches, e.g. by using an RF power divider 38. One portion of the signal flows through the tunable impedance 22 and, eventually, to the ADC 26 and the control element 20 if the self-diagnose operation is activated. Whereas, the remaining portion of the incoming signal flows directly to a second ADC 40 likewise connected to the control element 20. The power ratio of the two branches can be optimized during the design phase depending on the application scenario.

Hence, in this embodiment, it is sufficient to sample the incoming signal at both ADCs 26, 40 and subtract the two values to obtain the phase-difference between the associated paths \hat{θ}_{i,j}. The control element 20 can then compare \hat{θ}_{i,j} with the known reference, which is given by the current nominal unit cell configuration. Whenever a mismatch is detected, the corresponding unit cell may be dubbed as faulty.

To summarize, the present disclosure provides RIS device with self-diagnosis capabilities and methods for self-diagnosis of faulty RIS elements that exploit simple and passive components only, and that function in a transparent manner that does without requiring any additional control messages to be exchanged with the rest of the network. According to embodiments, the method/RIS device may comprise one or more of the following steps and/or components:
1) The RIS 10 may be equipped with an equivalent RF gate 24 (e.g., variable resistor, RF switch, etc.) and an ADC 26 at each unit cell, wherein the equivalent RF gate 24 enables redirecting the incoming signal to the central RIS controller 22. If necessary, an additional RF switch 36 and RF power divider 38 may be incorporated (in accordance with the embodiments described above).
2) The RIS central controller 22 (e.g., MCU) may activate the self-diagnosis procedure by closing the equivalent RF gate 24 of the RIS element 14 under test.
3) The central RIS controller 22 may collect a series of measurements from the ADC 26 and saving the maximum absolute value as a representative value. In other words, the ADC 26 added to the RIS 10 enables performing self-diagnosis of faulty RIS elements 14 by providing measurements of the incoming signal to the central RIS controller 22.
4) The central RIS controller 22 may compare such representative value of the RIS element 14 under test with the known reference value, which may be provided by any known functioning RIS element, and determine whether the RIS unit cell 14 under test is faulty or not.
5) Optionally, in the case of the phase-estimating implementation (as described above), a second ADC 40 can be incorporated to allow obtaining an estimate of the phase-shift applied by the RIS element 14 under test. In this case, the central RIS controller 22 may compare the representative value with the one corresponding to the parallel unshifted branch and subtract the two values to obtain an estimate of the phase-shift applied by the RIS unit cell 14 under test.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 reflective device
12 RIS board
14 reflective element
16 antenna element
18 phase shifter
20 control element
22 Impedance
24 RF gate
26 first analog-to-digital converter, ADC
28 Impedance
30 delay line
31 RF switch
32 PIN diode
34 varactor diode
36 first central RF switch
38 RF power divider
40 second analog-to-digital converter, ADC

1. A reflective device, comprising:
an array of reflective elements under control of a control element,
wherein each reflective element includes an antenna element configured to receive a radio-frequency (RF) signal incident on the reflective element, and
wherein each reflective element is configured to be operable in a functional operating state, in which the RF signal received by the antenna element of the reflective element is, at least partly, provided to be retransmitted by the antenna element of the reflective element, and in a diagnostic operating state, in which the RF signal received by the antenna element of the reflective element is, at least partly, provided as an RF signal usable for analysis purposes.

2. The reflective device according to claim 1, wherein each reflective element further comprises a switching mechanism configured to put the reflective element in either the functional operating state or the diagnostic operating state.

3. The reflective device according to claim 2, wherein:
each reflective element further comprises a phase shifter having a tunable impedance, the phase shifter being under control of the control element so as to reflect the RF signal received by the antenna element of the reflective element with an adjustable phase shift, wherein different phase shifts are realized by respectively tuning the tunable impedance of the phase shifter, and
the switching mechanism comprises an RF gate connected downstream to the tunable impedance of the phase shifter.

4. The reflective device according to claim 3, wherein:
in the functional operating state, the RF gate is configured to leave the phase shifter open-circuited, and/or
in the diagnostic operating state, the RF gate is configured to connect the phase shifter, directly or indirectly, with the control element.

5. The reflective device according to claim 3, wherein:
the phase shifter includes a set of discrete delay lines of different lengths and an RF switch connecting the antenna element with the discrete delay lines, the RF switch being configured to selectively activate a particular one of the discrete delay lines, and
the RF gate is implemented in a form of a variable impedance appended to an end of each of the discrete delay lines.

6. The reflective device according to claim 3, wherein:
the phase shifter includes one or multiple Positive-Intrinsic-Negative (PIN) diodes, and
the RF gate is implemented in a form of a variable impedance appended at an output side of the one or multiple PIN diodes.

7. The reflective device according to claim 3, wherein the phase shifter includes a varactor diode configurable in a number of different states depending on a value of a control voltage applied to the varactor diode.

8. The reflective device according to claim 3, further comprising a first central RF switch configured to forward, for one reflective element at a time, the RF signal, which is provided as the RF signal usable for analysis purposes when the respective reflective element is in the diagnostic operating state, to the control element.

9. The reflective device according to claim 8, further comprising a first analog-to-digital converter (ADC) implemented between the first central RF switch and the control element.

10. The reflective device according to claim 1, wherein the control element is configured to periodically activate the diagnostic operating state for each reflective element separately.

11. The reflective device according to claim 9, wherein each reflective element further comprises an RF power divider configured to split the RF signal incident on the reflective element,
wherein a first portion of the RF signal is directed to the control element via a first branch including the tunable impedance, the first central RF switch and the first ADC, and wherein a second portion of the RF signal is directed to the control element via a second branch including a second central RF switch and a second ADC.

12. The reflective device according to claim 11, wherein the control element is configured to:
sample incoming RF signals from the first branch and from the second branch and to determine a phase difference between the two RF signals;
compare the determined phase difference between the RF two signals with a reference value; and
qualify the corresponding reflective element as faulty in a case that the comparison reveals a discrepancy.

13. A method for operating the reflective device according to claim 1, the method comprising:
receiving, by the control element, an RF signal usable for analysis purposes provided by a reflective element in a diagnostic operating state and/or measurement values derived by a first ADC from the RF signal;
analyzing, by the control element, the received RF signal and/or the received measurement values; and
determining, by the control element based on the results of the analysis of the received RF signal and/or the received measurement values, whether the respective reflective element is faulty or not.

14. The method according to claim 13, wherein analyzing, by the control element, the received measurement values includes:
collecting a predefined or configurable series of measurement values;
determining, from the collected series of measurement values, a maximum absolute value as representative value;
comparing the representative value with a reference value; and
qualifying the corresponding reflective element as faulty in a case that the comparison reveals a discrepancy.

15. The method according to claim 14, further comprising:
diagnosing, by the control element, a malfunction in the antenna element of the corresponding reflective element when the representative value determined from the collected series of measurement values is above zero and lower than the reference value, and/or
diagnosing, by the control element, a malfunction in a tunable impedance of the corresponding reflective element when the representative value determined from the collected series of measurement values is zero.
